(19) United States
(12) Patent Application Publication
(10) Pub. No.: US 2025/0163989 A1
(43) Pub. Date: May 22, 2025

(54) ELECTRONICALLY CONTROLLED SHOCK ABSORBER HAVING DUAL SOLENOID VALVES

(71) Applicant: HL Mando Corporation, Pyeongtaek-si (KR)

(72) Inventor: Eunjoong KIM, Pyeongtaek-si (KR)

(21) Appl. No.: 18/679,612

(22) Filed: May 31, 2024

(30) Foreign Application Priority Data
Nov. 21, 2023 (KR) 10-2023-0161987

(51) Int. Cl. F16F 9/516

(52) U.S. Cl. CPC F16F 9/516; F16F 2222/126; F16F 2230/18

(57) ABSTRACT

The present disclosure provides an electronically controlled shock absorber having a solenoid valve, wherein the electronically controlled shock absorber includes: a cylinder (110) formed with an inner and outer dual structure, an inner space of which is divided into a compression chamber and a rebound chamber, and an outer space of which a reservoir chamber (117) is formed; a compression solenoid valve (180) mounted on an outside of the cylinder (110); and a rebound solenoid valve (190) mounted on an outside of the cylinder (110), wherein the compression solenoid valve (180) and the rebound solenoid valve (190) are disposed at predetermined intervals in a circumferential direction around a cylinder axis.

### CROSS-REFERENCE TO RELATED APPLICATION

This application claims priority under 35 U.S.C. § 119 to Korean Patent Application No. 10-2023-0161987, filed on Nov. 21, 2023, in the Korean Intellectual Property Office (KIPO), the disclosure of which is incorporated by reference herein in its entirety.

### TECHNICAL FIELD

The present disclosure relates to an electronically controlled shock absorber for a vehicle, and particularly to, an electronically controlled shock absorber having dual solenoid valves.

### BACKGROUND

During driving, a car constantly receives vibration or shock from a road surface through the wheels. When the vibration or shock transmitted through the wheels is transmitted to a car body and steering wheel, riding comfort and driving stability are significantly reduced. In order to alleviate such vibrations and shocks, a suspension device is essential for cars. Shock absorbers, springs, and suspension arms are the main constituents configuring the suspension device.

The shock absorber is configured of a cylinder, a piston rod, and a piston valve. The piston valve is coupled to the piston rod and is located inside the cylinder to generate damping force.

When the damping force of the shock absorber is set to a weak level, the riding comfort may be improved by absorbing vibrations caused by irregularities on the road surface. Conversely, when the damping force is set to a high level, changes in the posture of a car body are suppressed and steering stability is improved. Accordingly, in the past, it was common to select and apply shock absorbers with different damping force characteristics that were set depending on the purpose of use of a vehicle.

Recently, a damping force variable shock absorber capable of appropriately adjusting the damping force characteristics depending on the road surface and driving conditions has been developed by mounting a damping force variable valve capable of appropriately adjusting the damping force characteristics of the shock absorber.

As an example, referring to FIG. 1, a damping force variable shock absorber having a dual solenoid valve structure provided with a rebound solenoid valve 90 to adjust the damping force during a rebound stroke and a compression solenoid valve 80 to adjust the damping force during a compression stroke has been developed.

The interior of the cylinder configuring the shock absorber is divided into a compression chamber and a rebound chamber by the piston valve, and each chamber is filled with a fluid such as oil.

During the compression stroke, the piston valve pressurizes the fluid in the compression chamber, so that the compression chamber becomes high pressure and the rebound chamber becomes relatively low pressure. During the rebound stroke, the piston valve pressurizes the fluid in the rebound chamber, so that the rebound chamber becomes high pressure and the compression chamber becomes relatively low pressure.

Referring to FIGS. 2 to 5, the operating structure of the damping force variable shock absorber of Korean Patent Application Publication No. 10-2023-0068294 (Patent Document 1) having a dual solenoid valve structure will be reviewed.

During the compression stroke of FIGS. 2 and 3, the fluid in the compression chamber 13 flows into a compression separation tube 15 and moves to a reservoir chamber 17 through a compression solenoid valve 80. Some fluid moves to a rebound chamber 14 through a bypass flow path of the piston valve.

During the rebound stroke of FIGS. 4 and 5, the fluid in the rebound chamber 14 flows into a rebound separation tube 16 and moves to the compression chamber 13 through the compression solenoid valve 80 through a communication hole 103a of a rebound solenoid valve 90 and a connection portion 103. Some fluid moves to the compression chamber 13 through the bypass flow path of the piston valve.

However, the conventional electronically controlled shock absorber mounted with a dual solenoid valve has two solenoid valves 80 and 90 disposed in series in an axial direction of the shock absorber, thus making it difficult to secure mounting space.

In particular, in the case of vehicles applied with air springs, application of the dual solenoid valve is more difficult due to interference with the air spring.

### RELATED ART DOCUMENT

### Patent Document

(Patent Document 1) Korean Patent Application Publication No. 10-2023-0068294 (publication date: May 17, 2023)

### SUMMARY

The present disclosure is directed to addressing an issue associated with the related art, and to providing a disposition structure of a new dual solenoid valve capable of increasing the freedom of mounting of an electronically controlled shock absorber to which a dual solenoid valve is applied.

An electronically controlled shock absorber having dual solenoid valves according to an embodiment of the present disclosure includes: a cylinder formed with an inner and outer dual structure, an inner space of which is divided into a compression chamber and a rebound chamber, and an outer space of which a reservoir chamber is formed; a compression solenoid valve mounted on an outside of the cylinder; and a rebound solenoid valve mounted on an outside of the cylinder, wherein the compression solenoid valve and the rebound solenoid valve may be disposed at predetermined intervals in a circumferential direction around an axis of the cylinder.

In addition, the compression solenoid valve and the rebound solenoid valve may be located at the same height in an axial direction of the cylinder.

In addition, the compression solenoid valve and the rebound solenoid valve may be disposed side by side with each other.

In addition, the compression solenoid valve may be directly connected to the cylinder, and the rebound solenoid valve may be connected to the cylinder through a rebound pipe.

In addition, the cylinder may include an outermost base shell and an innermost inner tube; an upper rebound chamber and a lower compression chamber may be formed inside the inner tube; between the inner tube and the base shell, a rebound separation tube may be formed at an upper portion and a compression separation tube may be formed at a lower portion; the compression solenoid valve may be connected to the compression separation tube in the cylinder; and the rebound solenoid valve may be connected to the rebound separation tube in the cylinder through the rebound pipe.

In addition, one end of the rebound pipe may be connected to one end of a rebound valve housing of the rebound solenoid valve.

In addition, the rebound pipe may be connected to a rebound port at the other end facing the rebound separation tube.

In addition, the rebound port may be connected to the rebound separation tube.

In addition, the rebound pipe and the rebound port may be coupled by a coupler surrounding an outer periphery of an area where the rebound pipe and the rebound port come into contact with each other.

In addition, the compression solenoid valve and the rebound solenoid valve may be fixed by a solenoid block.

In addition, the rebound pipe may be connected to the rebound valve housing through the solenoid block.

In addition, the outer periphery of the coupler and the rebound pipe may be surrounded by a cover.

In addition, an electronically controlled shock absorber having dual solenoid valves according to another embodiment of the present disclosure may include: a cylinder formed with an inner and outer dual structure, an inner space of which is divided into a compression chamber and a rebound chamber, and an outer space of which a reservoir chamber is formed; a compression solenoid valve mounted on an outside of the cylinder; and a rebound solenoid valve mounted on an outside of the cylinder, wherein the compression solenoid valve and the rebound solenoid valve may be located at the same height in an axial direction of the cylinder.

In addition, during a compression stroke, fluid within the compression chamber may flow into the compression separation tube.

In addition, the fluid flowing into the compression separation tube may flow into the compression solenoid valve through a compression port and then be discharged and move to the reservoir chamber.

In addition, during a rebound stroke, fluid in the rebound chamber may flow into the rebound separation tube.

In addition, the fluid flowing into the rebound separation tube may flow into the rebound solenoid valve through the rebound pipe passing a rebound port.

In addition, the fluid flowing into the rebound solenoid valve may be discharged from the rebound solenoid valve and flow into the compression solenoid valve through a communication hole inside a connection portion connecting the compression solenoid valve and the rebound solenoid valve.

In addition, the fluid flowing into the compression solenoid valve may be discharged and moved to the compression chamber.

In the electronically controlled shock absorber having the dual solenoid valve according to an embodiment of the present disclosure configured as described above, the dual solenoid valve is disposed at the same height in a circumferential direction, thereby avoiding interference with other parts when mounted. Therefore, the freedom of mounting can be increased.

In addition, the dual solenoid valve can be applied also to car models to which air suspension is applied without interfering with the air suspension located in an upper portion of the valve.

### BRIEF DESCRIPTION OF THE DRAWINGS

FIG. 1 is a diagram schematically illustrating a conventional electronically controlled shock absorber to which a dual solenoid valve is applied.

FIGS. 2 and 3 are diagrams illustrating the flow of fluid during a compression stroke in the conventional electronically controlled shock absorber to which a dual solenoid valve is applied.

FIGS. 4 and 5 are diagrams illustrating the flow of fluid during a rebound stroke in the conventional electronically controlled shock absorber to which a dual solenoid valve is applied.

FIG. 6 is a diagram illustrating an electronically controlled shock absorber to which the disposition structure of a dual solenoid valve according to an embodiment of the present disclosure is applied.

FIG. 7 is a partial enlarged diagram illustrating the disposition structure of the dual solenoid valve of FIG. 6.

FIGS. 8 and 9 are diagrams illustrating the structure in which a rebound solenoid valve is connected to a rebound separation tube in the electronically controlled shock absorber according to an embodiment of the present disclosure.

FIG. 10 is a diagram illustrating the flow of fluid during a compression stroke in the electronically controlled shock absorber according to an embodiment of the present disclosure.

FIG. 11 is a diagram showing the flow of fluid during a rebound stroke in the electronically controlled shock absorber according to an embodiment of the present disclosure.

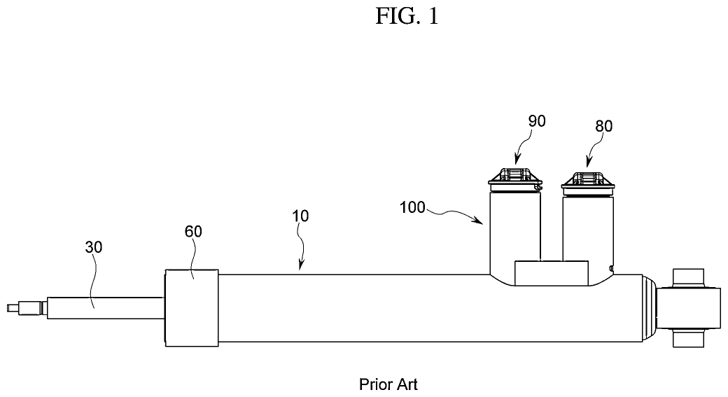

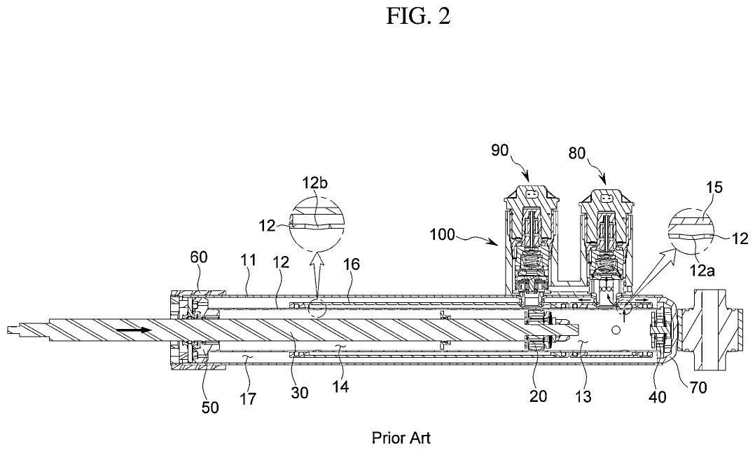

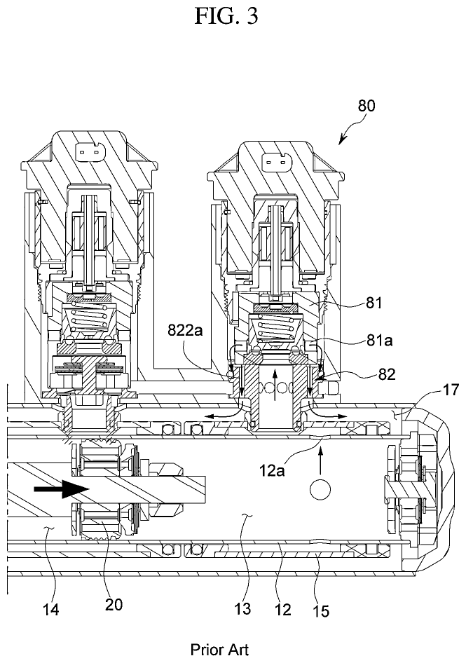

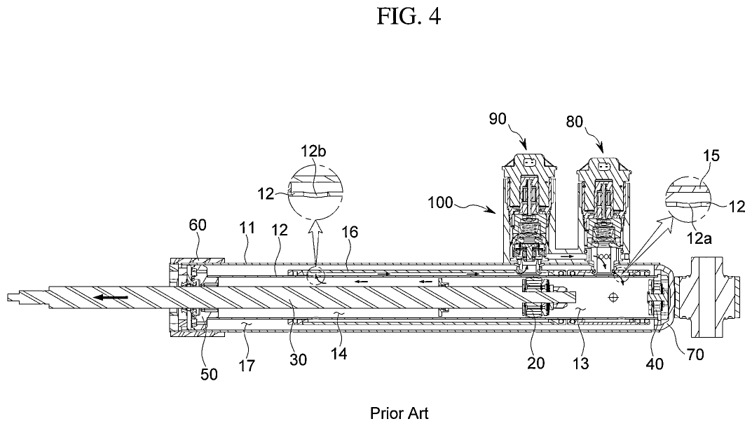

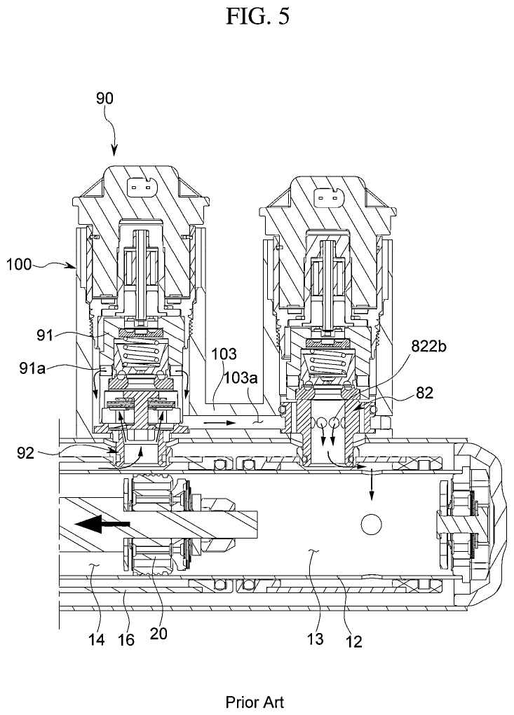

### DETAILED DESCRIPTION

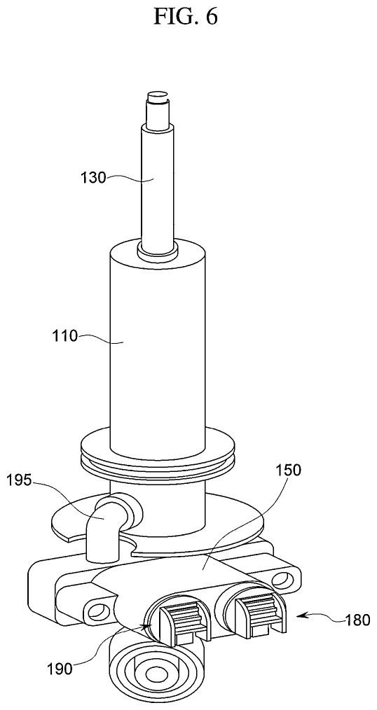

Hereinafter, an electronically controlled shock absorber to which a disposition structure of a dual solenoid valve according to an embodiment of the present disclosure is applied will be described in detail with reference to FIGS. 6 to 11.

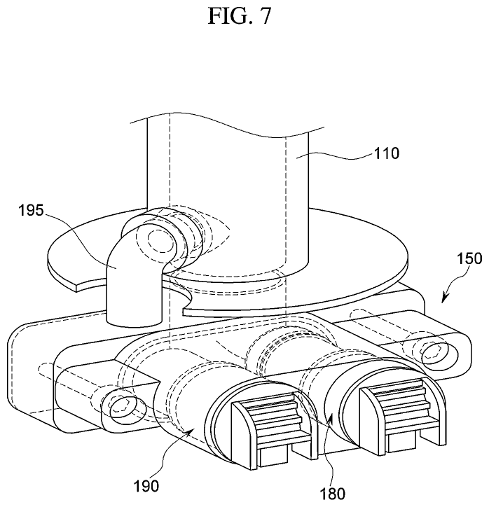

FIGS. 6 and 7 show an embodiment of the electronically controlled shock absorber to which the disposition structure of the dual solenoid valve according to an embodiment of the present disclosure is applied.

The electronically controlled shock absorber according to an embodiment of the present disclosure includes a cylinder 110, a piston valve (not shown), a piston rod 130, a body valve (not shown), a compression solenoid valve 180, and a rebound solenoid valve 190.

The compression solenoid valve 180 and the rebound solenoid valve 190 are not disposed in series in an axial direction of the shock absorber cylinder 110, but are disposed at predetermined intervals in a circumferential direction around the axis of the shock absorber. In other words, the compression solenoid valve 180 and the rebound solenoid valve 190 are located at the same height.

By disposing the dual solenoid valves at the same height in a circumferential direction, interference with other parts may be avoided during mounting, thereby increasing the freedom of mounting. In particular, the dual solenoid valve may be applied also to car models to which air suspension is applied without interfering with the air suspension located in an upper portion of the valve.

The compression solenoid valve 180 and the rebound solenoid valve 190 may preferably be disposed side by side with each other. In this connection, the compression solenoid valve 180 and the rebound solenoid valve 190 are fixed by a solenoid block 150 and disposed side by side with each other at the same height.

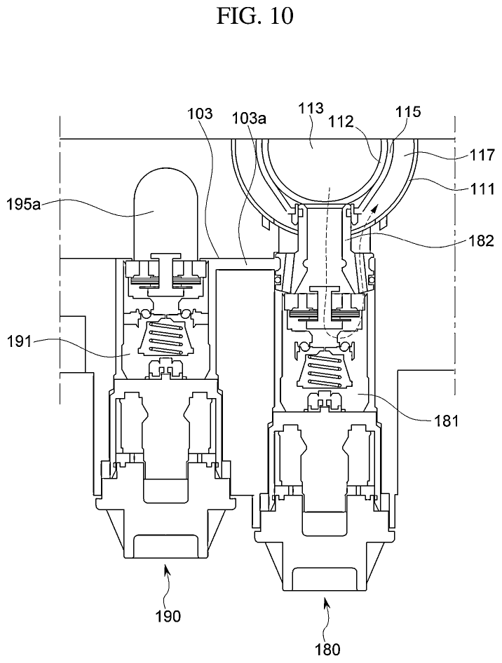

The compression solenoid valve 180 is connected to a compression separation tube 115 in the same way as a conventional electronically controlled shock absorber to which a dual solenoid valve is applied (see FIG. 10).

However, the rebound solenoid valve 190 is located at the same height as the compression solenoid valve 180, and thus may not be directly connected to a rebound separation tube 116 located thereabove. Hence, the rebound solenoid valve 190 is connected to the rebound separation tube 116 through a rebound pipe 195 (see FIGS. 6 to 9).

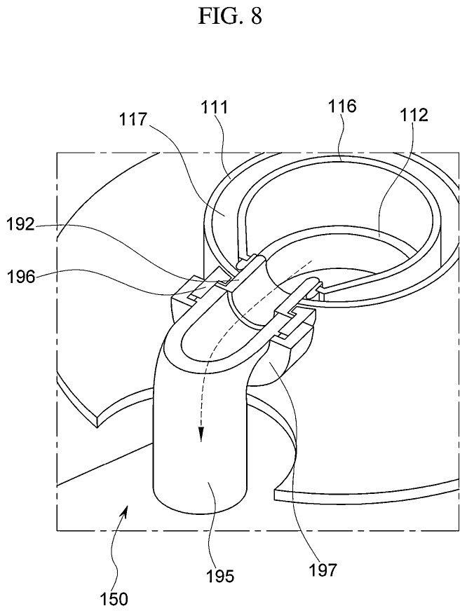

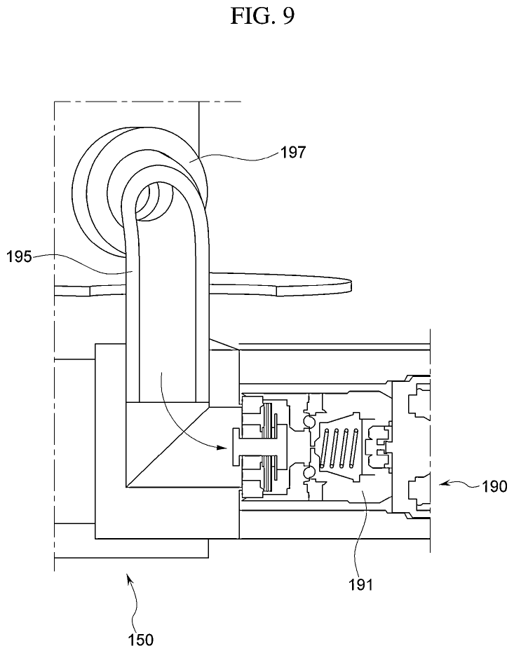

FIGS. 8 and 9 are diagrams illustrating the structure in which the rebound solenoid valve is connected to a rebound separation tube in the electronically controlled shock absorber according to an embodiment of the present disclosure.

Hereinafter, with reference to FIGS. 8 and 9, the structure in which the rebound solenoid valve 190 is connected to the rebound separation tube 116 will be described in detail.

The cylinder 110 includes an outermost base shell 111 and an innermost inner tube 112. Inside the inner tube 112, a rebound chamber is formed at an upper portion and a compression chamber is formed at a lower portion. Between the inner tube 112 and the base shell 111, the rebound separation tube 116 is located at an upper portion, and a compression separation tube 115 is located at a lower portion (see FIG. 10).

One end of the rebound pipe 195 is connected to one end of a rebound valve housing 191 of the rebound solenoid valve 190, the rebound pipe 195 is connected to a rebound port 192 at the other end facing the rebound separation tube 116, and the rebound port 192 is connected to the rebound separation tube 116.

The rebound pipe 195 may be connected to the rebound valve housing 191 through the solenoid block 150.

The rebound pipe 195 and the rebound port 192 are coupled by a coupler 196 surrounding the outer periphery of the area where the rebound pipe 195 and the rebound port 192 come into contact with each other. The outer periphery of the coupler 196 and the rebound pipe 195 is surrounded by a cover 197.

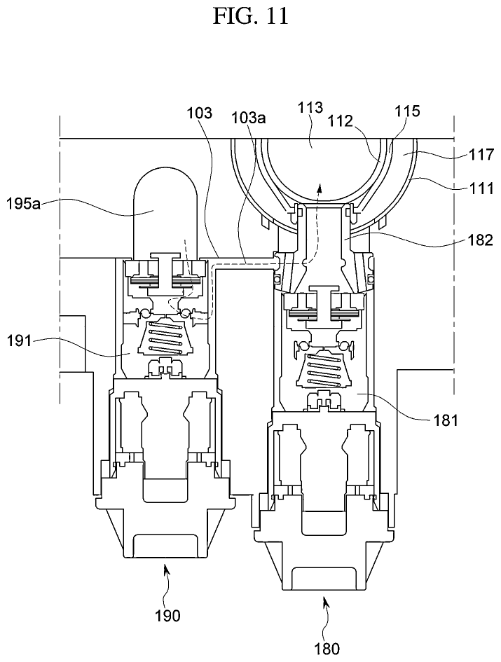

FIG. 10 shows the flow of fluid during a compression stroke in the electronically controlled shock absorber according to an embodiment of the present disclosure, and FIG. 11 shows the flow of fluid during a rebound stroke.

Referring to FIG. 10, during the compression stroke, the fluid in a compression chamber 113 flows into the compression separation tube 115, then flows into the compression solenoid valve 180 through a compression port 182, and then is discharged and moves to a reservoir chamber 117.

Referring to FIGS. 8 and 9, during a rebound stroke, the fluid in the rebound chamber flows into the rebound separation tube 116, and then flows into the rebound solenoid valve 190 through the rebound port 192 and the rebound pipe 195.

Then, referring to FIG. 11, the fluid is discharged from the rebound solenoid valve 190 and moves into the compression chamber 113 through the compression solenoid valve 180 through a communication hole 200a of a connection portion 200.

Hereinbefore, although the technical ideas of the present disclosure have been disclosed for illustrative purposes, a person having ordinary skill in the art to which the present disclosure pertains will appreciate that various modifications, variations and substitutions are possible, without departing from the essential characteristics of the present disclosure. Therefore, the embodiments of the present disclosure are disclosed only for illustrative purposes and should not be construed as limiting the technical ideas of the present disclosure, and the scope of technical ideas of the present disclosure is not limited by these embodiments. The scope of protection of the present disclosure should be interpreted in accordance with the claims below, and all technical ideas within the equivalent scope should be interpreted as being included in the scope of right of the present disclosure.

### DETAILED DESCRIPTION OF MAIN ELEMENTS

110: Cylinder
111: Base shell
112: Inner tube
113: Compression chamber
115: Compression separation tube
116: Rebound separation tube
117: Reservoir chamber
130: Piston rod
150: Solenoid block
180: Compression solenoid valve
182: Compression port
190: Rebound solenoid valve
191: Rebound valve housing
192: Rebound port
195: Rebound pipe
196: Coupler
197: Cover
200: Connection portion
200a: Communication hole

What is claimed is:

1. An electronically controlled shock absorber having dual solenoid valves, the electronically controlled shock absorber comprising:
a cylinder formed with an inner and outer dual structure, an inner space of which is divided into a compression chamber and a rebound chamber, and an outer space of which a reservoir chamber is formed;
a compression solenoid valve mounted on an outside of the cylinder; and
a rebound solenoid valve mounted on an outside of the cylinder,
wherein the compression solenoid valve and the rebound solenoid valve are disposed at predetermined intervals in a circumferential direction around an axis of the cylinder.

2. The electronically controlled shock absorber of claim 1, wherein the compression solenoid valve and the rebound solenoid valve are located at the same height in an axial direction of the cylinder.

3. The electronically controlled shock absorber of claim 2, wherein the compression solenoid valve and the rebound solenoid valve are disposed side by side with each other.

4. The electronically controlled shock absorber of claim 3, wherein:
the compression solenoid valve is directly connected to the cylinder; and
the rebound solenoid valve is connected to the cylinder through a rebound pipe.

5. The electronically controlled shock absorber of claim 4, wherein the cylinder comprises an outermost base shell and an innermost inner tube; an upper rebound chamber and a lower compression chamber are formed inside the inner tube; and between the inner tube and the base shell, a rebound separation tube is formed at an upper portion and a compression separation tube is formed at a lower portion;
the compression solenoid valve is connected to the compression separation tube in the cylinder; and
the rebound solenoid valve is connected to the rebound separation tube in the cylinder through the rebound pipe.

6. The electronically controlled shock absorber of claim 5, wherein one end of the rebound pipe is connected to one end of a rebound valve housing of the rebound solenoid valve.

7. The electronically controlled shock absorber of claim 6, wherein the rebound pipe is connected to a rebound port at the other end facing the rebound separation tube.

8. The electronically controlled shock absorber of claim 7, wherein the rebound port is connected to the rebound separation tube.

9. The electronically controlled shock absorber of claim 8, wherein the rebound pipe and the rebound port are coupled by a coupler surrounding an outer periphery of an area where the rebound pipe and the rebound port come into contact with each other.

10. The electronically controlled shock absorber of claim 9, wherein the compression solenoid valve and the rebound solenoid valve are fixed by a solenoid block.

11. The electronically controlled shock absorber of claim 10, wherein the rebound pipe is connected to the rebound valve housing through the solenoid block.

12. The electronically controlled shock absorber of claim 11, wherein the outer periphery of the coupler and the rebound pipe is surrounded by a cover.

13. An electronically controlled shock absorber having dual solenoid valves, the electronically controlled shock absorber comprising:
a cylinder formed with an inner and outer dual structure, an inner space of which is divided into a compression chamber and a rebound chamber, and an outer space of which a reservoir chamber is formed;
a compression solenoid valve mounted on an outside of the cylinder; and
a rebound solenoid valve mounted on an outside of the cylinder,
wherein the compression solenoid valve and the rebound solenoid valve are located at the same height in an axial direction of the cylinder.

14. The electronically controlled shock absorber of claim 13, wherein:
the compression solenoid valve is directly connected to the cylinder; and
the rebound solenoid valve is connected to the cylinder through a rebound pipe.

15. The electronically controlled shock absorber of claim 14, wherein the cylinder comprises an outermost base shell and an innermost inner tube; an upper rebound chamber and a lower compression chamber are formed inside the inner tube; and between the inner tube and the base shell, a rebound separation tube is formed at an upper portion and a compression separation tube is formed at a lower portion;
the compression solenoid valve is connected to the compression separation tube in the cylinder; and
the rebound solenoid valve is connected to the rebound separation tube in the cylinder through the rebound pipe.

16. The electronically controlled shock absorber of claim 15, wherein, during a compression stroke, fluid within the compression chamber flows into the compression separation tube.

17. The electronically controlled shock absorber of claim 16, wherein the fluid flowing into the compression separation tube flows into the compression solenoid valve through a compression port and then is discharged and moves to the reservoir chamber.

18. The electronically controlled shock absorber of claim 15, wherein, during a rebound stroke, fluid in the rebound chamber flows into the rebound separation tube.

19. The electronically controlled shock absorber of claim 18, wherein the fluid flowing into the rebound separation tube flows into the rebound solenoid valve through the rebound pipe passing a rebound port.

20. The electronically controlled shock absorber of claim 19, wherein the fluid flowing into the rebound solenoid valve is discharged from the rebound solenoid valve and flows into the compression solenoid valve through a communication hole inside a connection portion connecting the compression solenoid valve and the rebound solenoid valve.

21. The electronically controlled shock absorber of claim 20, wherein the fluid flowing into the compression solenoid valve is discharged and moves to the compression chamber.
